(19) United States
(12) Patent Application Publication
(10) Pub. No.: US 2017/0039228 A1
(43) Pub. Date: Feb. 9, 2017

(54) SYSTEM AND METHOD FOR SHARING GRAPH STRUCTURED INFORMATION WHICH ARE REPLICATED ACROSS A PLURALITY OF USER DEVICES THROUGH A LOCAL NETWORK, AND METHOD FOR SYNCHRONIZATION AND REPLICATION OF GRAPH STRUCTURED INFORMATION

(71) Applicant: TOHTT SERVIÇOS DE TECNOLOGIA LTDA, Pernambuco (BR)

(72) Inventors: Mohamad Al Skafi, Saida (LB); Tarcisio de Meira Lins Filho, Recife (BR)

(21) Appl. No.: 15/228,419

(22) Filed: Aug. 4, 2016

Related U.S. Application Data
(60) Provisional application No. 62/259,270, filed on Nov. 24, 2015.
(60) Provisional application No. 62/200,837, filed on Aug. 4, 2015.

(51) Int. Cl. G06F 17/30; H04L 29/08

(52) U.S. Cl. CPC G06F 17/30309; H04L 67/1091; G06F 17/30374; G06F 17/30356; G06F 17/30958; G06F 17/30775

(57) ABSTRACT

A system and method are provided for sharing graph structured information which are replicated across a plurality of user devices through a local network, comprising a server for providing an channel for communicating graph of data objects with the user devices, a data controller for managing data. The data controller comprising an offline module for managing the graph of data objects stored in the system before sharing the objects in the sharing environment, and an online module for handling all the network communication with user devices and the server. The system creates a sharing environment in which the user devices are connected and each user device is able to share graph of data objects in said sharing environment, wherein the data controller performs at least one sync operation to guarantee that the data shared in the sharing environment is consisting between all user devices.

### CROSS-REFERENCE TO RELATED APPLICATIONS

This application claims priority to and benefit of U.S. Provisional Patent Application No. 62/259,270 filed on Nov. 24, 2015 and U.S. Provisional Patent Application No. 62/200,837 filed on Aug. 4, 2015, the entire contents of each of which are hereby incorporated by reference herein in their entirety.

### TECHNICAL FIELD

The present disclosure generally relates to the operation of data networks, and more particularly, to systems and methods of listening to music via a network device.

### DESCRIPTION OF RELATED ART

In recent years, the use of electronic devices such as smartphones, tablet computers, personal computers, and the like has become widespread. In parallel, advances in technology have resulted in the development and deployment of extensive data networks. These networks include both public data networks, such as the Internet, and specialized networks, such as wireless telecommunication networks. Users of these networks have the ability to access a wide variety of information and services that are available as network resources.

One example where there is an increasing demand for network resources is in wireless network environments. In wireless environments, a variety of wireless devices, such as wireless telephones, personal digital assistants (PDAs), and paging devices, communicate over a wireless network. The wireless network may also include network servers that operate to provide various network resources to the wireless devices. Furthermore, the wireless networks may also be coupled to a public network, such as the Internet, so that resources on the public network may be made available to the wireless devices on the wireless network.

In one particular area, users may download or stream songs and other content to a wireless device via a wireless network. A user may listen to, or otherwise view, content using a wireless device. Listening to music streamed over a wireless network on a mobile device is prone to interruption due to losses in network connectivity. These losses of connectivity may occur for a variety of reasons, e.g., environmental reasons, system initiated reasons, user initiated reasons, etc. From a user's standpoint, losing connectivity when listening to streaming music may be very frustrating.

In order to mitigate this, collaborative apps are available on mobile devices, which facilitate the participation of users to take part in a joint collaboration to assemble and collectively access a collection of items. However, it common that data consistency problems occurs between the data being shared in this joint collaboration, since each of the user devices has its own manner of indexing and recognizing the data stored in the user device, which may not match the index and data of other user devices.

Therefore, it is of a particular interest a system and method capable of managing data stream, specifically music streaming, among a plurality of users connected to the interne, wherein such data streaming is carried out in a safe and practical manner and when listening to streaming music via a wireless device.

### BRIEF SUMMARY

The present disclosure relates to a method and system for sharing graph structured information which are replicated across a plurality of user devices through a sharing environment, which lets user devices who are in physical proximity of one another, to join on a network for sharing music. The network is created by an original user device and take part on the music mixing from within each other used device configured to play music, such as smartphone, a notebook or a tablet.

According to an exemplary embodiment of the present disclosure, when a user connects his user device to the system, a collaborative music session among the users of the system who are in proximity to one another is created and songs can be added to the session. A Mixer page then opens on the device showing the user's playlist and music controls.

Other users with connected to system can view, in their own user devices, all collaborative music session in progress proximate to their location. When the other users select a collaborative music session, a mixer page with a playlist corresponding to the selected collaborative music session opens on each of their respective user devices.

Once users have joined a particular collaborative music session, any one of the users participating in the collaborative music session can add music to the playlist from within their own user devices.

For example, to add a song to the playlist of the collaborative music session, the user clicks a button to add music, selects songs to be added, and the songs are immediately displayed at each user's device. The songs are streamed through the master device, i.e., the user who originated a collaborative music session or the “owner” of the session, when the time comes to play the selected song.

The present disclosure provides a system and method for sharing graph structured information which are replicated across a plurality of user devices through a local network, the system comprising a server for providing an channel for communicating graph of data objects with the user devices, a data controller for managing data, the data controller comprising an offline module for managing the graph of data objects stored in the system before sharing the objects in the sharing environment, an online module for handling all the network communication with user devices and the server, wherein the system creates a sharing environment in which the user devices are connected and each user device is able to share graph of data objects in said sharing environment, wherein the data controller performs at least one sync operation to guarantee that the data shared in the sharing environment is consisting between all user devices.

The present disclosure also discloses a method for synchronization and replication of graph structured information across a plurality of user devices through a sharing environment, the method comprises the steps of search, in requesting user device among the user devices, for an object; send request to the other user devices for information about said object, up from locally stored information by version; in response to the request, each other user device generates a locally reachable object list from the requested list of objects each user device assumes that the requesting user device does not have objects that are not included in the reachable object list and those objects are added in said reachable object list; the user devices generate log(s) from the requested object's versions and sends the log(s) to the requesting user device; in response to receiving the log(s), the requesting user device merges the log(s) into the objects while respecting temporal reference consistency.

### BRIEF DESCRIPTION OF THE DRAWINGS

The present disclosure is explained in greater detail below on the basis of figures. Shown therein are:

FIG. 1 describes the process of authoring graphs of subsets.

FIG. 2 describes an example of objects referencing to other objects, according to an embodiment of the present disclosure.

FIG. 3 describes the process of synchronization and replication of graph structured information.

### DETAILED DESCRIPTION

The present disclosure relates to a system and method for sharing graph structured information which are replicated across a plurality of user devices through a local network. Although the embodiments of the present disclosure are related to sharing music, one person skilled in the art would notice that any other data can be shared using the beneficial and new solution proposed by the present disclosure.

In embodiments described below, each device has a subset of the information. Any two devices involved in the system can share information to keep each other up to date with their respective views on the shared data. The distributed nature of keeping information means that there is no single point of loss for data which has already been shared. That implies that a centralized server could be completely replaced with a from-scratch server and the system will still be able to function as expected. The referential graph system caters to composing a graph of objects from different origins while respecting temporal guarantees about objects shared in changes to referencing objects.

The system uses a data controller for managing the data stored in the user device and the data, which is intended for sharing from all other user devices connected to the sharing environment. In order to perform these functions, the data controller comprises an offline module and an online module.

The data controller is responsible for managing data and allowing that many of the objects in the system be represented by a graph of objects. There is no limitation on the graph structures of the objects, nor on the origin of those composed object graphs. For example, the graph structures may be circular graphs, or any other suitable graph structures, and the objects may include but are not limited to self-including objects.

Each object can potentially originate from a different source for example, user profiles, user comments, songs, reports, etc. The data controller allows objects to be composed from different origins without violating the constraint on the origin of any edits.

An object of a specific version may depend on other objects from any origin of a specific version. The data controller makes the issue of sending updates of those objects automatic, after having received a reference to them through other means. Thus, a semantic guarantee is given on how objects that have references to each other can be co-updated. For example, the data controller guarantees that updates for objects of a specific version will also simultaneously update the referenced objects to a least acceptable version of those objects in a recursive manner.

The updates are performed with basis on a pull based, version diff tool approach to reconcile and synchronize subsets of the graph starting with an object or a set of objects of interest. The diff utility is a data comparison tool that calculates and displays the differences between two files. The diff tool displays the changes made in a standard format, such that both humans and machines can understand the changes and apply them: given one file and the changes, the other file can be created.

In this manner, the present disclosure allows that updates are not subject to network consensus issues. By only updating objects that are of current interest to the respective devices, the data controller does not overwhelm the network by updating all objects stored in the graph system on disk.

In an embodiment, the update mechanism is implemented by representing the different types of objects as a linear log of respective operations. The operations are diff'ed, serialized and transmitted over the network. The merging of those diff's on the other side is conflict free since each change for a particular object originates from a single device, even though a third-party device may relay that change.

Two examples of how this may be accomplished are a peer-to-peer network and through the internet. In a peer to peer network objects are updated between peers. Peers share the details of objects they have in store even when those objects did not originate within them. This means that the author of an object being processed to the group of users by the data controller, known as “sync objects”, does not necessarily need to be involved in relaying said sync object to other users. In the Internet version, object updates are sent to a server. Consumers of those objects can periodically check for updates on those objects.

To send updates, the data controller traverses object graphs so that required updates to referenced objects are sent before the respective updates on the containing objects. This ensures that the receiver sees a causally consistent stream of update events. For example, when syncing a profile contained within a “profiles set”, the added profile will not be added into the receiver user device's version of the “profiles set” until that profile is brought up to the required version. Preferably, this is all performed within the confines of a single update message, so there are no additional latency concerns.

In an embodiment of the present disclosure, only owners of the sync objects may alter those objects. Alternatively, in another embodiment of the present disclosure, the system may require permission for non-authors of the object to access and/or modify the objects. In addition, the system may require permission for non-authors of the object to relay it to other peers. For example, when a collaborative music session ends and two peers remain on the network of a bigger set of peers, it is interesting that the system establishes a permission level so that the object cannot be shared indefinitely between the peers.

In an alternative embodiment of the present disclosure, the system limit the subset of the global graph stored on any of the devices. This is interesting in order to maintain the sharing environment independently of a single user device, since, in case a single device holds a large amount of the global graph, its disconnection from the sharing environment could cause an inconsistency in the graph information.

In an alternative embodiment of the present disclosure, the system relay objects indiscriminately to peers. This is interesting in order to maintain a simple sharing environment between the user devices, which cause better performance of the system.

Yet in an alternative embodiment of the present disclosure, the user devices relay updates for objects even if they are not locally authored. This is interesting for spreading data over the user devices, since a single user device may be the author of many objects in the sharing environment.

In an alternative embodiment of the present disclosure, the user devices poll updates only for currently interesting objects. Alternatively, the user devices may opportunistically send updates for changing objects to surrounding interested devices. These operations are interesting for prioritizing updates when there are many objects needing to have its information updated.

According to an embodiment of the present disclosure, the system comprises a server for providing an alternate channel for communicating updates. Object updates are pushed from any device to the server. The server contains a global graph of objects. In various embodiments, the server may or may not author sync object items depending on the particular system configuration. The server understands object versions, and log dependencies and caters requested updates accordingly.

According to the present disclosure, user devices connected to the collaborative music session can create text data corresponding to the collaborative music session, in which such text date are shared in the sharing environment. These text data are, for example, comments from the users regarding the songs being reproduced in the playlist of the sharing environment. Preferably, the data controller selects the text data provided by the user devices in the sharing environment that will be included in the collaborative music session.

Each user device in the sharing environment receives a reference to the collaborative music session, which automatically publishes all the other players' comments. Each user device can observe the collaborative music session and each of the text data. This allows each participant to observe all relevant text data in the collaborative music session. Preferentially, the text data are comments submitted by a user of the user device, and such comments may correspond to a specific song or to the collaborative music session.

According to the present disclosure, every user device that has access to the sharing environment has a copy of its user profile. This enable the user device to access information stored in the user device through the data controller, even when the user device is totally offline. Preferentially, the user profile is created during a registration step that is requested from the user for the first time that he have access to the system. When a user registers with the system, he adds his profile's unique identifier, known as a user ID and receive a list of the user ID's of profiles on other user devices. However, a user can access information stored in the user device through the data controller even when the registration step is skipped.

In certain embodiments, this is done manually, particularly in configurations where there is no possible single authority on the playlist except for the server. In other embodiments, where the server is configured to implement the whole sync system's semantics this process may be automated. Each user device syncs each of those profiles to the latest available version. The profiles are merged using timestamps on their corresponding fields.

According to the present disclosure, the data controller comprises an offline module and an online module. The offline module is a manager local to a single user device that provides a view of the distributed graph, locally, without networking capabilities. The offline module does not have a view of the local network and manages the objects. Examples of operations performed by the offline module are, but not limited to, versioning, extracting logs for updates, merging logs. The offline module and the accompanying objects are a distributed graph of objects with a single author for each of the objects. The objects are versioned, by their authors. The sync objects are the graph objects that are managed by the offline module and shared through the distributed graph.

Object types are dictionary, set, array and value. Value objects contain data, for example, archived JSON objects. Value objects are always leaf objects in the graph. Objects can compose different objects. This is true even when objects come from different authors. Objects can recursively compose through references, i.e. an object referencing itself or eventually being referenced through following references in the graph. Objects have versions. Each change nominally changes the version at least once. Objects reference other versions with a least-version requirement.

Sending object updates means sending logs of relationship changes and any required updates to bring the referenced objects up to the least acceptable version. This may be implemented by updating to current object version instead.

The offline module allows syncing the graph using log arrays of JSON-like objects. The offline module is not concerned with the transport of logs.

The data controller is a thread safe system. Operations performed through the offline module, or any of the graph objects, potentially concurrent, guarantee either failing, or being linearizable. Editing and observation of the values and the graph are separated. The values are accessible in parallel, in a queue of updates. The updates may lag behind the local edits that are happening to the graph, but are guaranteed to catch up to all the updates within a fixed time (which is short, but there is no hard limit, due to platform limitations.).

According to the present disclosure, the data controller also comprises an online module. The online module is a wrapper around the system that is network aware and handles all the automatic network communication with peers and the server, as opposed to the offline module which is totally oblivious to networking. The offline module communicates with the outside world through a network, such as internet or even a local area network.

Additionally, the online module organizes the objects in the offline module. The online module is the main entry point to the library and has access to the network environment, and a view of connected devices on the local network. The online module sends messages to user devices to synchronize local objects and responds to requests for data. Therefore, the online module uses both the network and the own offline module's library. It syncs the graph with nearby connected user devices and the server. The online module only opts to auto-update objects that have been already fetched and not yet de-allocated.

Security on the system is achieved in several ways. One way security is implemented is to limiting changes to only originate from object authors, i.e., all authored changes will be signed.

Another way security is implemented is by restricting access. For example, objects will have access qualifiers (e.g. access lists) that clients in the distributed network will respect. Alternatively, for more security, each expected recipient would have an object encrypted by their public key, at the detriment of bandwidth and ability to update through other users.

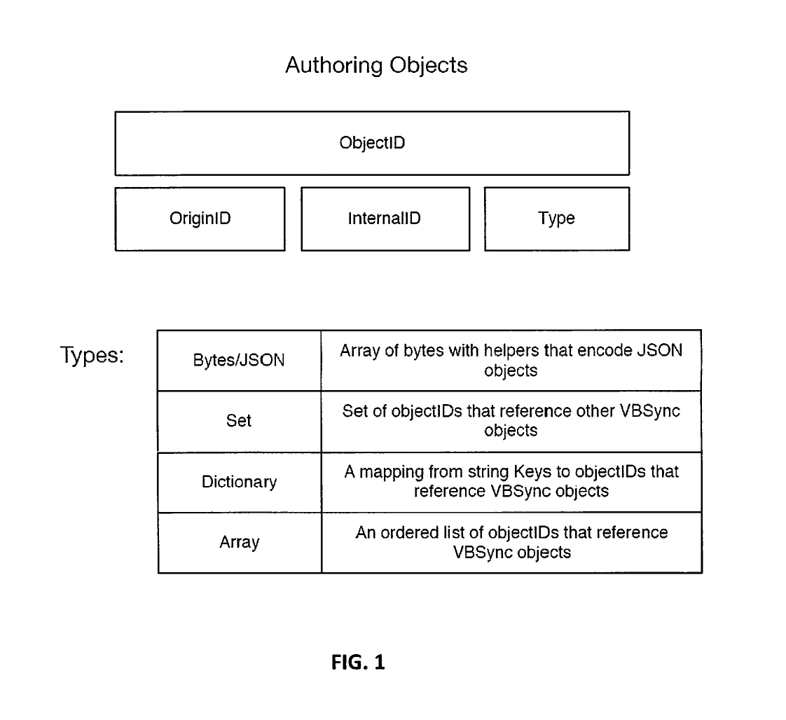

With reference to FIG. 1, authoring graph subsets will be described. When creating new objects, the user device can claim ownership to these objects. Each object has an object ID, an origin ID, an internal ID, and a type. Those object types can be versioned leaf data objects that only hold information in the form of bytes. Alternatively, those objects types can be structured graph elements which can be one of ‘set’, ‘dictionary’, or ‘array.’ Graph elements compose from other objects which may be other composed objects or leaf objects.

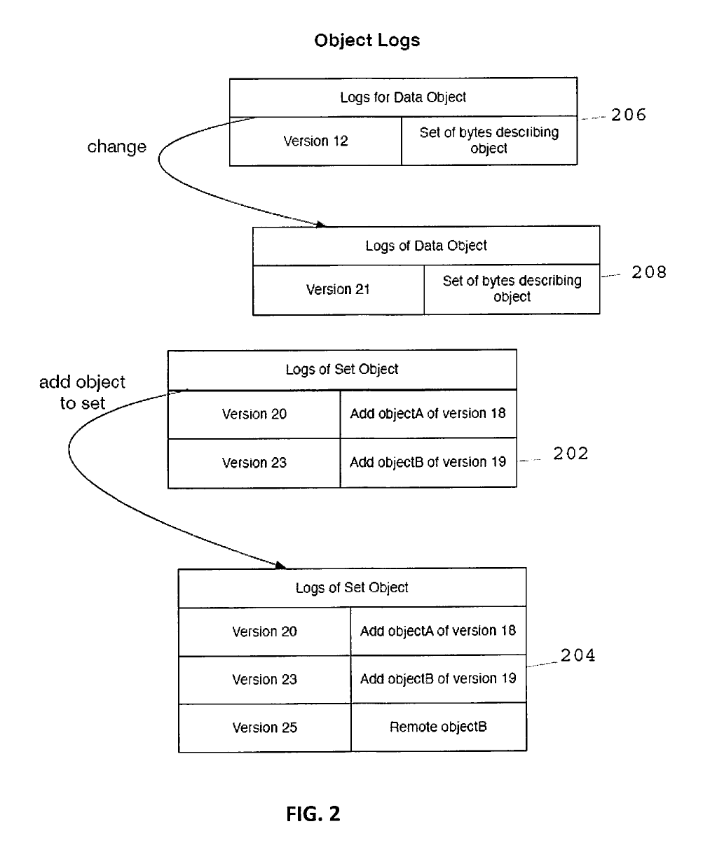

Turning to FIG. 2, when objects reference other objects, they add a version requirement of that object. For example, when an object is added to “Logs of Set Object” 202, the log is changed as depicted in “Logs of Set Object” 204 where “Version 25: Remote objectB” is added. Changes to local objects keep history of those objects for both composed or for leaf-data objects. In another example, “Version 12” of “Logs of Data Object” 206 is changed to “Version 21” as depicted in “Logs of Data Object” 208.

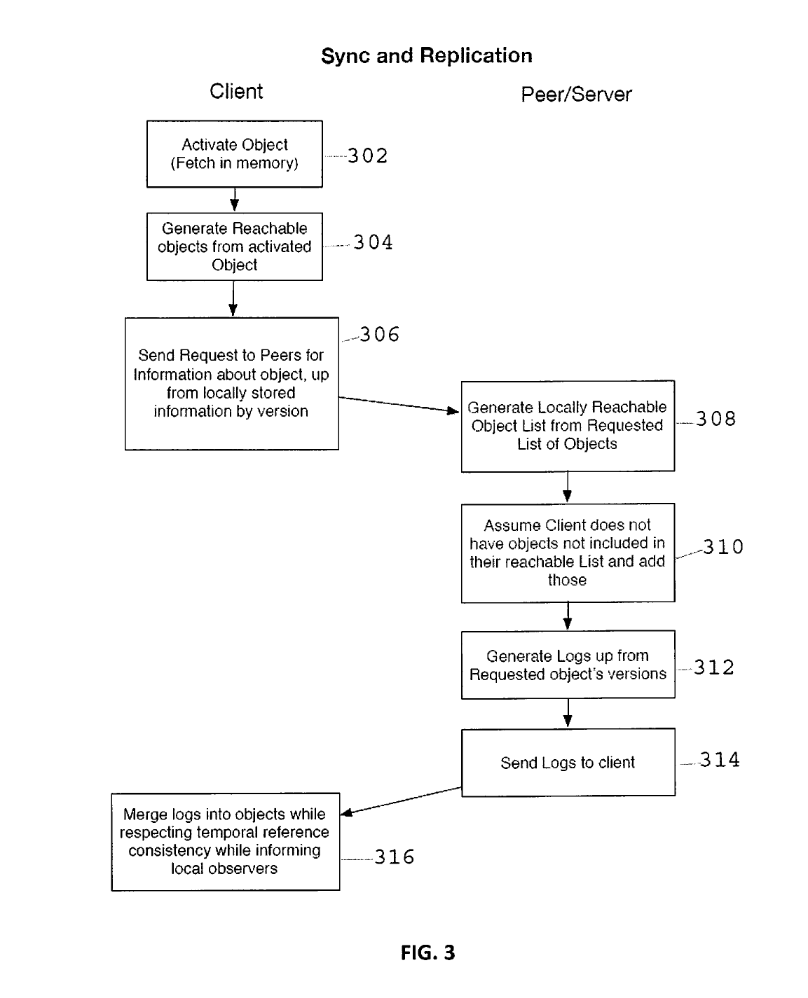

FIG. 3 is a flow diagram of a method 300 of synchronization and replication, according to an embodiment. The synchronization and replication is performed by either the client or peer(s)/server(s), which communicate with each other. At 302, the client activates an object, for example, fetches data from memory. Reachable objects are generated from activated object(s) at 304. A request is sent to the peer(s)/server(s) for information about the object at 306, up from locally stored information by version. In response to the request, each peer/server generates a locally reachable object list from the requested list of objects at 308. Each peer assumes that the client does not have objects that are not included in the reachable object list and those objects are added at 310. The peer/server generates log(s) from the requested object's versions at 312 and sends the log(s) to the client at 314. In response to receiving the log(s), the client merges the log(s) into the objects while respecting temporal reference consistency while informing local observers at 316.

According to the preferred embodiment of the present disclosure, Syncing Graph Subsets when two devices sync an object is accomplished in two possible manners. When the object is a leaf object, only information to get that object from one version to the other is needed, possibly by overriding the old information with a new one.

However, if the object is a composed object, then all objects that are reachable through any number of reference-following starting from that object are prepared for syncing, and the requesting device generates a version list of all objects reachable based on its view of the graph. The requested-from device then generates a diff structure based on what changes are needed to bring the objects on the referencing-side needs, and which new objects will be reachable after the sync is finished, and sends this information back. The requesting device applies the changes while respecting version guarantees of the underlying objects for composed objects. A set which adds an object at version V will always require updating the object to version V before adding it to the set on another device.

FIG. 4 shows an embodiment of the present disclosure, where a first plurality of user devices, represented as nodes, create a first sharing environment, whereas a second plurality of user devices create a second sharing environment. All user devices of the sharing environment are connected to the serve. Different nodes in the system can persist different objects, and use the LAN and the central server to coordinate syncing objects. Therefore, the present disclosure provided the following advantages:
Sync is always conflict free since objects are always changed from a single device
Eventual consistency on common objects between any two peers that are connected to each other or through the server
Eventual consistency is transitive between more than two peers per object
Higher level cooperative data types can be represented within this system without having to worry about communication.

The illustrative embodiments of the present disclosure described herein may be implemented using hardware, software or any combination thereof and may be implemented in one or more computer systems or other processing systems. Additionally, one or more of the steps described in the example embodiments herein may be implemented, at least in part, by machines. Example machines that may be useful for performing the operations of the example embodiments herein include general purpose digital computers, specially-programmed computers, desktop computers, server computers, client computers, portable computers, mobile communication devices, tablets, and/or similar devices.

For instance, an example system for performing the operations of the embodiments herein may include one or more components, such as one or more microprocessors, for performing the arithmetic and/or logical operations required for program execution, and storage media, such as one or more disk drives or memory cards (e.g., flash memory) for program and data storage, and a random access memory, for temporary data and program instruction storage.

The system may also include software resident on a storage media (e.g., a disk drive or memory card), which, when executed, directs the microprocessor(s) in performing transmission and reception functions. The software may run on any operating system stored on the storage media, and can adhere to various protocols such as the Ethernet, ATM, TCP/IP protocols and/or other connection or connectionless protocols.

As is well known in the art, microprocessors can run different operating systems, and can contain different types of software, each type devoted to a different function, such as handling and managing data/information from a particular source, or transforming data/information from one format into another format. The embodiments described herein are not to be construed as being limited for use with any particular type of server computer, and that any other suitable type of device for facilitating the exchange and storage of information may be employed instead.

Software embodiments of the example embodiments presented herein may be provided as a computer program product, or software, that may include an article of manufacture on a machine-accessible or non-transitory computer-readable medium (also referred to as “machine-readable medium”) having instructions. The instructions on the machine accessible or machine readable medium may be used to program a computer system or other electronic device. The machine-readable medium may include, but is not limited to, floppy diskettes, optical disks, CD-ROMs, and magneto-optical disks or other type of media/machine-readable medium suitable for storing or transmitting electronic instructions.

The techniques described herein are not limited to any particular software configuration. They may be applicable in any computing or processing environment. The terms “machine-accessible medium”, “machine-readable medium” and “computer-readable medium” used herein shall include any non-transitory medium that is capable of storing, encoding, or transmitting a sequence of instructions for execution by the machine (e.g., a CPU or other type of processing device) and that cause the machine to perform any one of the methods described herein. Furthermore, it is common in the art to speak of software, in one form or another (e.g., program, procedure, process, application, module, unit, logic, and so on) as taking an action or causing a result. Such expressions are merely a shorthand way of stating that the execution of the software by a processing system causes the processor to perform an action to produce a result.

While various example embodiments have been described above, it should be understood that they have been presented by way of example, and not limitation. It will be apparent to persons skilled in the relevant art(s) that various changes in form and detail can be made therein.

1. A system for sharing graph structured information which are replicated across a plurality of user devices through a local network, the system comprising:
a server configured to provide a channel for communicating a graph of data objects with the plurality of user devices; and
a data controller configured to manage data, the data controller comprising:
an offline module configured to manage the graph of data objects stored in the system before sharing the objects in a sharing environment;
an online module configured to handle all the network communication with the plurality of user devices and the server;
wherein the system creates the sharing environment in which the plurality of user devices are connected and each user device is able to share the graph of data objects in the sharing environment, and
wherein the data controller performs at least one sync operation to guarantee that the data shared in the sharing environment is consistent between all user devices.

2. The system, according to claim 1, wherein the sync operation includes authoring graph subsets, in which each object has an object ID, an origin ID, an internal ID, and a type including leaf data objects or structured graph elements which can be one of ‘set’, ‘dictionary’, or ‘array.

3. The system, according to claim 1, wherein the sync operation includes referencing other objects and adding a version requirement of that object.

4. The system, according to claim 1, wherein the objects originate from a different source consisting of at least one of user profiles, comments, songs and reports.

5. The system, according to claim 1, wherein the offline module performs at least one among versioning the data, extracting logs for updates, or merging logs.

6. The system, according to claim 1, wherein user devices connected to the sharing environment can create text data corresponding to the data shared in the sharing environment, in which such text date are shared in the sharing environment upon authorization from the data controller.

7. The system, according to claim 1, wherein the data controller allows objects to be composed from different origins without violating the constraint on the origin of any edits.

8. The system, according to claim 1, wherein the data controller sends updates to other connected devices automatically after receiving a reference to them during communication.

9. The system, according to claim 8, wherein the data controller guarantees that updates for objects of a specific version will also simultaneously update the referenced objects to a least acceptable version of those objects in a recursive manner.

10. The system, according to claim 8, wherein the updates are performed with basis on a pull based, version diff tool approach to reconcile and synchronize subsets of the graph starting with an object or a set of objects of interest.

11. The system, according to claim 8, wherein the updates are implemented by representing the different types of objects as a linear log of respective operations, wherein the operations are diff'ed, serialized and transmitted over the network.

12. The system, according to claim 8, wherein the data controller traverses object graphs so that required updates to referenced objects are sent before the respective updates on containing objects.

13. The system, according to claim 1, wherein only the authors of an object shared in the sharing environment can change the object.

14. The system, according to claim 1, wherein each user device needs a permission from the system to create or upload data in the sharing environment.

15. The system, according to claim 1, wherein the online module is the main entry point to the data stored in the system and has access to the network environment, and a view of connected devices on the local network, wherein the online module sends messages to user devices to synchronize local objects and responds to requests for data.

16. The system, according to claim 1, wherein the online module only opts to auto-update objects that have been already fetched and not yet de-allocated.

17. A method for sharing graph structured information which are replicated across a plurality of user devices through a local network, the method comprising the steps of:
providing a network channel for communicating a graph of data objects with the plurality of user devices;
managing the graph of data objects stored in the system before sharing the objects in a sharing environment;
handling all the network communication with the plurality of user devices and the server; and
creating the sharing environment in which the plurality of user devices are connected and each user device is able to share the graph of data objects in the sharing environment,
wherein at least one sync operation is performed to guarantee that the data shared in the sharing environment is consistent between all user devices.

18. A method for synchronization and replication of graph structured information across a plurality of user devices through a sharing environment, the method comprising:
searching, in requesting a user device among the plurality of user devices, for an object;
sending a request to the other user devices for information about the object, up from locally stored information by version;
in response to the request, generating, by each other user device, a locally reachable object list from the requested list of objects;
assuming, by each user device, that the requesting user device does not have objects that are not included in the reachable object list and those objects are added in said reachable object list;
generating, by the user devices, log(s) from the requested object's versions and sends the log(s) to the requesting user device; and
in response to receiving the log(s), merging, by the requesting user device, the log(s) into the objects while respecting temporal reference consistency.

19. The method, according to claim 18, wherein in case the object is a leaf, only information to get that object from one version to the other is needed, overriding the old information with a new one.

20. The method, according to claim 18, wherein in case the object is a composed object, and the method further comprises:
all objects that are reachable through any number of reference-following, starting from that object are prepared for syncing;
generating, by the requesting user device, a version list of all objects reachable based on its view of the graph;
generating, by the requested-from device, among the other user devices, a diff structure based on what changes are needed to bring the objects on the referencing-side needs, and which new objects will be reachable after the synchronization is finished, and sending this information back; and
applying, by the requesting user device, the changes while respecting version guarantees of the underlying objects for composed objects.
